(19) United States
(12) Patent Application Publication
(10) Pub. No.: US 2025/0362531 A1
(43) Pub. Date: Nov. 27, 2025

(54) HINGE-BASED HEAD-WORN DEVICE POWER CONTROL

(71) Applicant: Snap Inc., Santa Monica, CA (US)

(72) Inventors: Shaheen Moubedi et al., Los Angeles, CA (US); Mathias Andreas Hintermann, Culver City, CA (US); John Recchio, Los Angeles, CA (US)

(21) Appl. No.: 19/208,350

(22) Filed: May 14, 2025

Related U.S. Application Data
(60) Provisional application No. 63/650,792, filed on May 22, 2024.

(51) Int. Cl. G02C 11/00; G02B 27/01; G02C 5/22

(52) U.S. Cl. CPC G02C 11/10; G02B 27/0176; G02C 5/22; G02B 2027/0178

(57) ABSTRACT

A head-worn device is presented, featuring an intuitive power control mechanism based on the device's physical hinge states. The device includes a pair of hinges, each connecting a temple piece to the frame, capable of transitioning between open and closed positions. Sensors, such as Hall effect sensors, detect these positions and output signals accordingly. A hardware logic circuit receives the signals, controlling the device's power state-activating when both hinges are open and deactivating when closed. The system also incorporates hardware security circuitry that forcibly disables hardware components like cameras and microphones in the inactive state, ensuring user privacy. This power control mechanism is designed to be robust against unintended activations and integrates seamlessly with the user's natural interactions with the eyewear, offering a secure, convenient, and user-friendly experience.

### CLAIM OF PRIORITY

This application claims the benefit of priority to U.S. Provisional Application Ser. No. 63/650,792, filed on May 22, 2024, which is incorporated herein by reference in its entirety.

### TECHNICAL FIELD

The present disclosure relates generally to display devices and more particularly to display devices used for extended reality.

### BACKGROUND

A head-worn device may be implemented with a display, such as transparent or semi-transparent display through which a user of the head-worn device can view the surrounding environment. Such devices can enable a user to view virtual visual content (e.g., virtual objects such as 3D renderings, images, video, text, and so forth) on the display, and in some cases to see through the transparent or semi-transparent display to view the surrounding environment. The virtual visual content may be generated for display to appear as a part of, and/or overlaid upon, the surrounding environment. This is typically referred to as “extended reality” or “XR”, and it encompasses techniques such as augmented reality (AR), virtual reality (VR), and mixed reality (MR). Each of these technologies combines aspects of the physical world with virtual content presented to a user.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a perspective view of a head-worn device, in accordance with some examples.

FIG. 2 illustrates a top view of the head-worn device of FIG. 1 with both hinges in the open position, in accordance with some examples.

FIG. 3 illustrates a detailed partial top view of the left hinge area of the head-worn device of FIG. 1 with the left hinge in the open position, in accordance with some examples.

FIG. 4 illustrates a top view of the head-worn device of FIG. 1 with both hinges in the closed position, in accordance with some examples.

FIG. 5 illustrates a detailed partial top view of the left hinge area of the head-worn device of FIG. 1 with the left hinge in the closed position, in accordance with some examples.

FIG. 6 illustrates a block diagram of a system for controlling a head-worn device, in accordance with some examples.

FIG. 7 illustrates a circuit diagram of a circuit implementation of the hardware logic circuitry and hardware security circuitry of the system of FIG. 6, in accordance with some examples.

FIG. 8 is a flowchart illustrating operations of a first example method for controlling a head-worn device, in accordance with some examples.

FIG. 9 is a flowchart illustrating operations of a second example method for controlling a head-worn device, in accordance with some examples.

FIG. 10 is a diagrammatic representation of a machine in the form of a computer system within which a set of instructions may be executed to cause the machine to perform any one or more of the methodologies discussed herein, in accordance with some examples.

FIG. 11 is a block diagram showing a software architecture within which examples may be implemented.

### DETAILED DESCRIPTION

XR eyewear devices, smart glasses, and other head-worn devices may integrate advanced computing technology with eyeglass frames to provide users with an immersive visual experience, capture video and audio data, and/or present users with audio and/or video output. These devices typically include a variety of sensors, input/output interfaces, and computational hardware.

In the realm of XR eyewear, power management is a critical aspect that affects user experience, device longevity, and safety. Traditional methods of controlling power states in portable electronic devices range from mechanical switches to touch-sensitive interfaces and proximity sensors. Each of these methods presents unique challenges in terms of integration, intuitiveness, and reliability. The design of an effective power control interface for XR eyewear may consider factors such as the compact form factor of the device, the ease of use for the wearer, and the need for robustness to prevent unintended device activation or deactivation.

Manual power switches have several potential limitations. They can be difficult to integrate into a head-worn device, because the electromechanical components take up space. They may be hard to find and/or unintuitive to use (e.g., if found, their purpose may not be apparent). They also may not be robust, as users can forget to turn the head-worn device back off, thereby draining power, which is often at a premium in head-worn devices. In addition, they are not simple, because the user needs to perform one additional step when stowing or otherwise discontinuing use of the device.

Proximity sensors, using sensing modalities such as ultrasound or infrared light to sense proximity of a user's head, can also be difficult to integrate into a head-worn device, as they may need hardware components such as antennas or infrared lights, which may need to be calibrated. They may not be robust, potentially generating false positives depending on the user's head shape, hair, skin tone, and so on. Finally, proximity sensors do not give the user or other bystanders a sense of hardware security, because it may not be apparent when the device has been activated or deactivated, leading to uncertainty about whether sensitive functions such as camera, microphone, and/or network communication functions are still operating.

Examples described herein attempt to address one or more of these limitations by providing a power and security control system specifically designed for head-worn devices, such as XR eyewear. The system utilizes the natural motion of opening and closing the eyewear's hinges as a user interface for toggling the device's power states. This approach leverages the inherent action associated with putting on or removing glasses, thereby offering an intuitive and convenient method for controlling the device.

In some examples, a head-worn device includes a pair of sensors, one associated with each hinge of the temple pieces of the device. The sensors are capable of detecting the open or closed state of the hinges. In some examples, the sensors are Hall effect sensors, which respond to changes in the magnetic field as the hinges move. The signals from these sensors are then processed by hardware logic circuitry, which is designed to change the power state of the device only when both hinges are detected to be in the same position-either both open or both closed.

In some examples, the hardware logic circuitry includes a Schmitt trigger circuit, which ensures that the power state toggles only when both sensors simultaneously indicate a transition. This circuit may include a pull-up resistor, a comparator, and an operational amplifier (op-amp). The pull-up resistor is connected to a voltage rail, setting an initial threshold voltage for the circuit. The comparator receives the signals from the sensors and determines whether the hinges are in the open or closed position. The op-amp then amplifies the comparator's output, providing a stable signal to control the power state of the device.

In addition to managing power states, some examples also enhance the security and privacy of the head-worn device. When the device is in the off state, hardware security circuitry is configured to force disable the camera(s) and/or microphone(s) of the device, ensuring that no sensitive data (e.g., audio or visual data) is recorded or transmitted, thereby addressing privacy concerns. In some examples, the device may present an indication perceptible to human bystanders, such as a visual or auditory indication, that the device is inactive.

Various examples of the hinge sensors and hardware logic circuitry are described herein. The hardware logic circuitry may be designed to enter and maintain a sleep state before fully powering off if the hinges remain closed for a predetermined period, providing energy-saving benefits without compromising user convenience. This feature may allow a user to fold the arms of the head-worn device temporarily or partially without immediately deactivating the device.

Thus, some examples described herein may provide a robust, secure, and user-friendly solution for power and security control in XR eyewear and other head-worn devices, with the potential to significantly enhance the user experience.

Other technical features may be readily apparent to one skilled in the art from the following figures, descriptions, and claims.

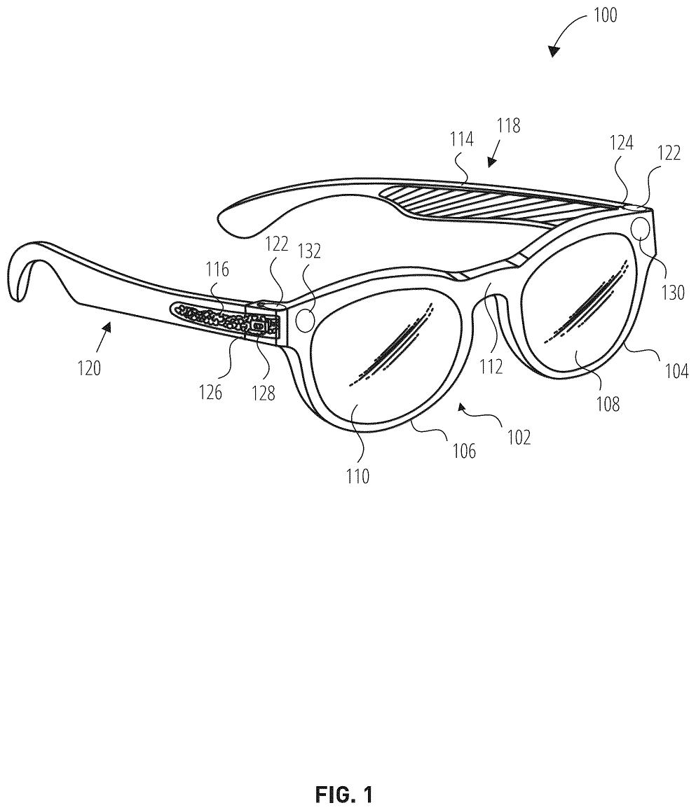

FIG. 1 is a perspective view of a head-worn XR device (e.g., glasses 100), in accordance with some examples. The glasses 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing.

The frame 102 additionally includes a left arm or left temple piece 118 and a right arm or right temple piece 120. The temple pieces 118, 120 are pivotally connected to the frame 102 via a left hinge 124 and a right hinge 126. These hinges 124, 126 allow the temple pieces 118, 120 to transition between an open position and a closed position relative to the frame 102, facilitating the wearing and storage of the glasses 100. In some examples the frame 102 can be formed from a single piece of material so as to have a unitary or integral construction. In some examples, such as the illustrated example, the temple pieces 118 and 120 are pivotally mounted to the front portion of the frame 102 by respective hinges 124 and 126. Each side of the frame 102 has an end piece 128 extending back from the respective optical element holders 104 and 106 to the hinges 124 and 126.

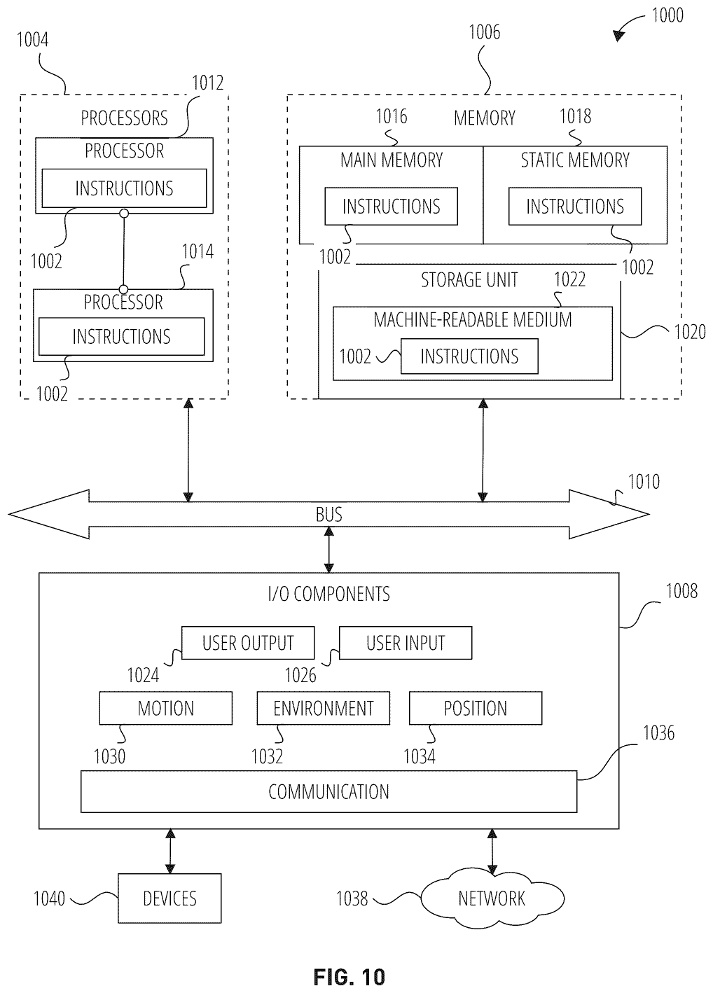

The glasses 100 can include a computing device, such as a computer 116, which can be of any suitable type so as to be carried by the frame 102 and, in one or more examples, of a suitable size and shape so as to be partially disposed in one of the left temple piece 118 or the right temple piece 120. The computer 116 can include one or more processors with memory, wireless communication circuitry, and a power source. As discussed below, the computer 116 comprises low-power circuitry, high-speed circuitry, and a display processor. Various other examples may include these elements in different configurations or integrated together in different ways. Machine 1000, described below with reference to FIG. 10, provides an example implementation of the computer 116.

The computer 116 additionally includes a battery 114 or other suitable portable power supply. In some examples, the battery 114 is disposed in the left temple piece 118 and is electrically coupled to the computer 116 disposed in the right temple piece 120. The glasses 100 can include a connector or port (not shown) suitable for charging the battery 114, a wireless receiver, transmitter or transceiver (not shown), or a combination of such devices. In some examples, power and/or data connections between the computer 116, the battery 114, and/or other components of the glasses 100 may be provided in part via one or more flexible conduits passing through or around the hinges 124 and 126.

User input may be provided by one or more buttons 122, which in the illustrated examples are provided on the outer upper edges of the left optical element holder 104 and right optical element holder 106. The one or more buttons 122 may provide a means whereby the glasses 100 can receive input from a user of the glasses 100. In some examples, various other input modalities may be used instead of or in addition to the buttons 122, such as the various user input components 1026 described below with reference to FIG. 10.

The glasses 100 can include one or more sources of sensitive data, such as one or more cameras, microphones, and/or other environmental sensors (as described in more detail with reference to the example machine 1000 in reference to FIG. 10). The example shown in FIG. 1 includes a left camera 130 and a right camera 132 configured to capture images or videos of the environment in front of the glasses 100. Other examples described below may also include one or more microphones (not shown) for capturing sounds from the environment. The glasses 100 may also have one or more communication subsystems, such as a wireless communication subsystem, for communicating with other devices, as described in more detail with reference to the machine 1000 of FIG. 10 below.

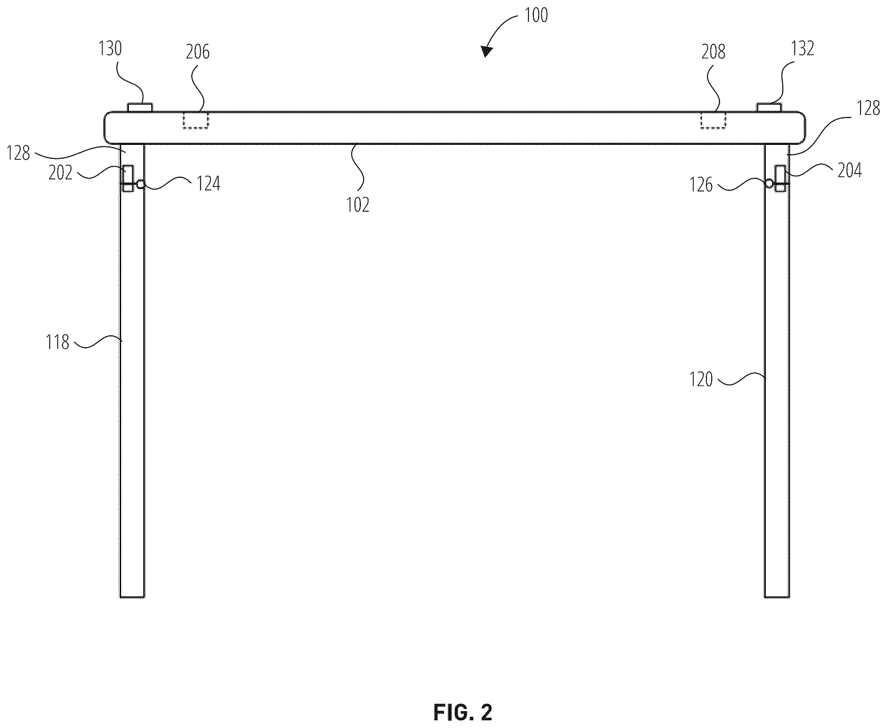

FIG. 2 illustrates a top view of the glasses 100 with the left hinge 124 and right hinge 126 in the open position. Each hinge 124, 126 pivotally couples its respective temple piece (left temple piece 118 and right temple piece 120, respectively) to the frame 102 (specifically, to a respective end piece 128 on the left or right end of the frame 102). A sensor is positioned within or proximate to each hinge (shown as first sensor 202 integrated into left hinge 124 and second sensor 204 integrated into right hinge 126). The sensors 202 and 204 are described in greater detail below.

The glasses 100 are shown having two cameras (left camera 130 and right camera 132) mounted on the frame 102, as well as a left microphone 206 and right microphone 208 mounted on the frame 102 (shown in dashed lines to indicate placement on the underside of the frame).

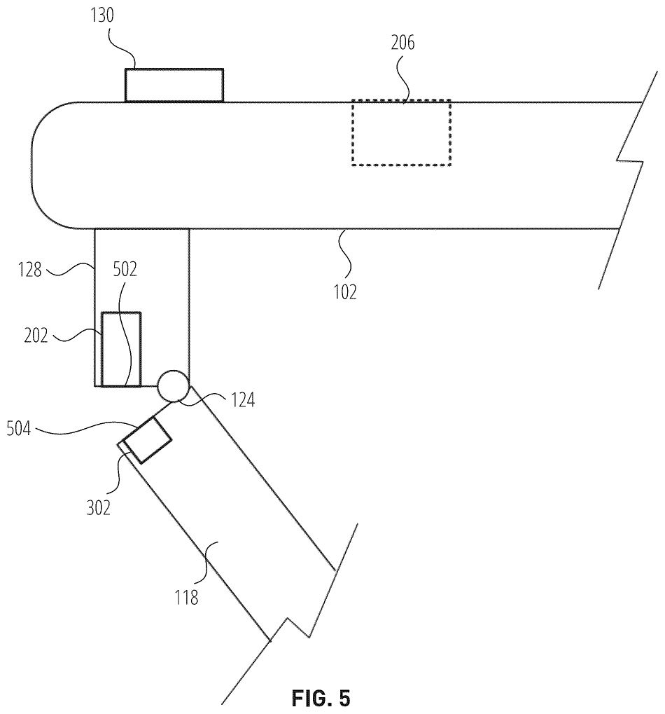

When the hinges 124, 126 are in the open position, as shown, corresponding faces of the temple piece and frame (e.g., the end piece of the frame) abut each other at the position of the hinge. The faces are described below with reference to FIG. 5. The abutment of the faces, one of which includes the sensor, results in the sensor generating a signal indicating that the corresponding hinge is in the open position. Otherwise, the sensor generates the signal to indicate that the corresponding hinge is in the closed position. In some examples, depending on the nature of the sensors and their configuration, the sensors may detect the open position when the faces are near to abutment, such as when an angle between the two faces is lower than a threshold angle, or when a distance between the two faces is less than a threshold distance.

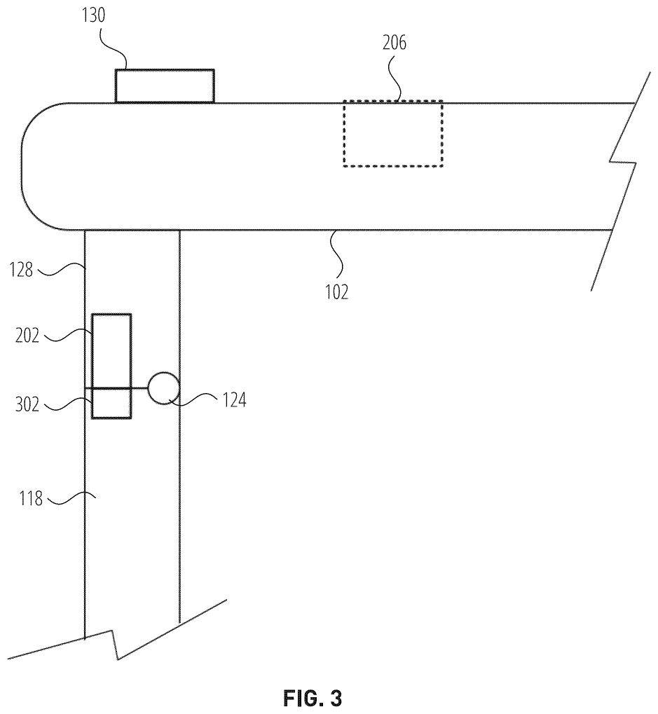

FIG. 3 illustrates a detailed partial top view of the left hinge area of the glasses 100 with the left hinge in the open position. In this example, the first sensor 202 is a Hall effect sensor configured to detect changes in the local magnetic field. The first sensor 202 is incorporated into one of the faces (in this example, the face of the frame 102), and a magnet 302 is incorporated into the corresponding opposite face (in this example, the face of the left temple piece 118). When the magnet 302 comes into contact or near-contact with the first sensor 202 due to the abutment of the respective faces of the frame 102 and left temple piece 118, the first sensor 202 generates a signal indicating that the left hinge 124 is in the open position.

In some embodiments, the first sensor 202 could be a rotational sensor integrated within the hinge mechanism itself. Such a sensor would be capable of detecting the precise angular position of the hinge, providing a granular level of control over the device's operational state based on the degree of rotation of the temple piece relative to the frame 102. Additionally, the first sensor 202 could be a different type of contact sensor, such as a mechanical pressure sensor, which would respond to physical contact or pressure changes as the hinge moves.

The implementation of the sensor and/or magnet may vary based on design considerations. For example, the magnet 302 could be positioned on the frame 102, and the first sensor 202 on the left temple piece 118. The materials and specifications of the magnet and sensor can also be selected to optimize performance, durability, and cost-effectiveness. The sensor's sensitivity and the magnet's strength may be calibrated to ensure reliable detection while minimizing the risk of false positives or negatives due to external magnetic fields or mechanical jostling.

The first sensor 202 is configured to generate a signal, such as a voltage or current signal, indicating whether the left hinge 124 is in the open position or the closed position. Similarly, on the right side of the glasses 100, the second sensor 204 is configured to generate a signal indicating whether the right hinge 126 is in the open position or the closed position. Thus, when the glasses 100 are in the configuration shown in FIG. 2, the first sensor 202 generates a first signal indicating that the left hinge 124 is in the open position, and the second sensor 204 generates a second signal indicating that the right hinge 126 is in the open position.

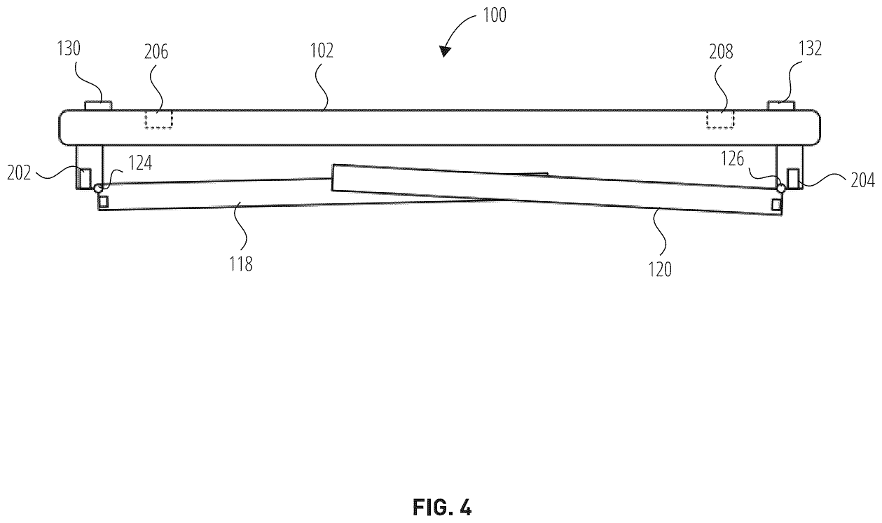

FIG. 4 illustrates a top view of the glasses 100 with both hinges in the closed position. In the closed position, the left temple piece 118 and right temple piece 120 are both folded inward at least partially from their fully-extended configuration in the open position. In some examples, the left temple piece 118 and right temple piece 120 can be folded over each other to cover, at least partially, the user-facing surfaces of the frame 102 and its associated components (e.g., the left optical element holder 104, right optical element holder 106, left optical element 108, and right optical element 110), thereby at least partially protecting the user-facing surfaces of the device. The closed position also makes the glasses 100 more compact, for ease of storage.

FIG. 5 illustrates a detailed partial top view of the left hinge area of the glasses 100 with the left hinge 124 in the closed position. In this example, the left temple piece 118 is only partially folded inward toward the frame 102, in contrast to the fully-folded closed position shown in FIG. 4.

The end piece 128 of the frame 102 defines a first face 502, and the left temple piece 118 defines a second face 504. These faces 502, 504 abut each other when the left hinge 124 is in the open position, but are rotated away from each other when the left hinge 124 is in the closed position. In some examples, depending on the configuration of the sensors and magnets, the first sensor 202 may detect any rotation of the left temple piece 118 (and thus the second face 504) of more than a very small angle away from the first face 502 and treat such rotation as a transition to the closed position. In other examples, the angle of rotation may need to be more pronounced in order to register as a transition to the closed position. In examples using Hall effect sensors, the proximity of the magnet 302 to the first sensor 202 may need to be quite close to register the change in magnetic field, and therefore to register as indicating the open position; such a requirement of close proximity may serve to reduce the effects of noise from external magnetic fields causing false positives or false negatives.

Thus, when the glasses 100 are in the configuration shown in FIG. 5, the first sensor 202 generates a first signal indicating that the left hinge 124 is in the closed position, and the second sensor 204 generates a second signal indicating that the right hinge 126 is in the closed position.

One alternative to Hall sensors and magnets for implementing the first sensor 202 and second sensor 204 is to use an electrical contact sensor in each arm. A pair of complementary electrical contacts, such as contact pads and/or spring-loaded pogo pins (as commonly used in earbud chargers), can be placed on the first face 502 and a corresponding position on the second face 504 that close a circuit when abutting each other. In another example, two surfaces of rotating elements of the hinge (e.g., left hinge 124) could be provided with complementary electrical contacts, such that rotation of two components of the hinge causes the contacts to align or misalign rotationally.

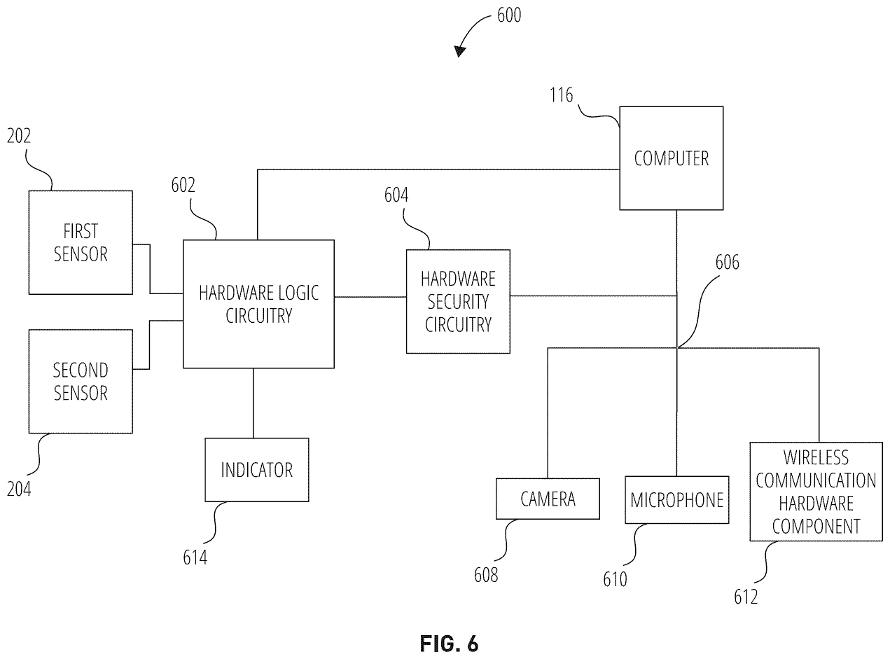

FIG. 6 illustrates a block diagram of a system 600 for controlling a head-worn device, such as the glasses 100, using the sensors described above.

The system 600 includes hardware logic circuitry 602 configured to receive the first signal and second signal from the first sensor 202 and second sensor 204, respectively, and to control a state of the head-worn device based on the detected positions of both hinges as indicated by the signals. If the head-worn device is in the inactive state and the hardware logic circuitry 602 receives both a first signal indicating that the left hinge 124 is in the open position, as well as a second signal indicating that the right hinge 126 is in the open position, the hardware logic circuitry 602 causes the head-worn device to transition to an active state. Similarly, if the head-worn device is in the active state and the hardware logic circuitry 602 receives both a first signal indicating that the left hinge 124 is in the closed position, as well as a second signal indicating that the right hinge 126 is in the closed position, the hardware logic circuitry 602 causes the head-worn device to transition to an inactive state.

The active state is a state in which the head-worn device is operational and powered on. In some examples, the inactive state is a state in which the head-worn device is at least partially non-operational and operating in at least a reduced power state relative to the active state, such as a powered-off state, a sleep state, or a hibernation state. In some examples, the inactive state is a fully powered-off state in which power draw for the processor and other major computing components is zero or close to zero, and all functions are disabled other than those required for detecting a reactivation trigger. By requiring both hinges 124, 126 to change position in order to transition between the active and inactive states, the system 600 can potentially avoid false positives and unintended power cycling.

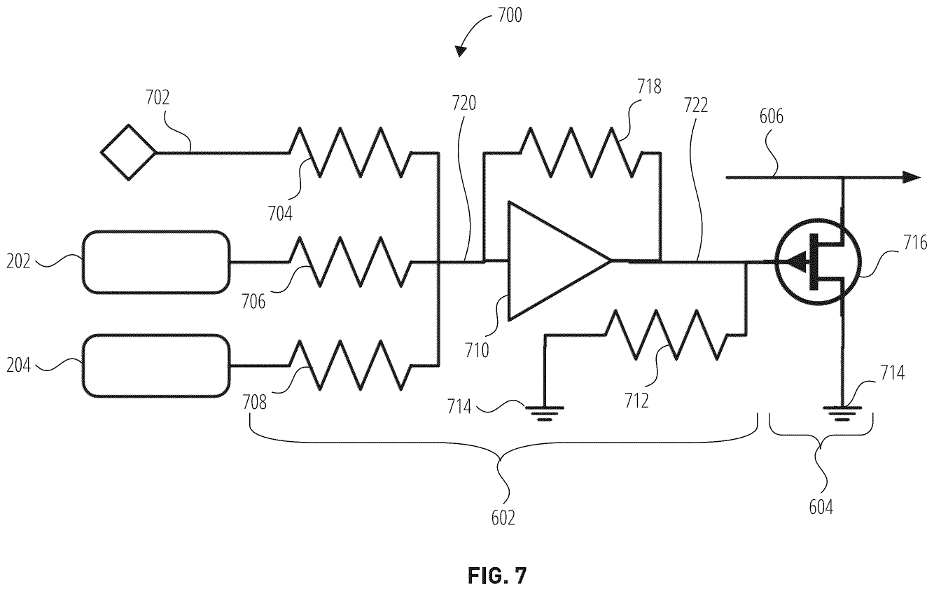

In some examples, the hardware logic circuitry 602 is implemented as electronic hardware independent of software control. A hardware implementation, such as the circuit implementation described below with reference to FIG. 7, can provide a robust, secure, and efficient means of power switching.

The system 600 also includes hardware security circuitry 604 triggered or activated by the hardware logic circuitry 602 when the head-worn device is in, or enters, the inactive state. The hardware security circuitry 604 force disables at least one hardware component of the head-worn device in response to being triggered (e.g., in response to receiving a disable signal from the hardware logic circuitry 602). As used herein, to “force disable” a component means to actively and deliberately turn off or deactivate the component, ensuring that it cannot function or perform its intended operation. In the context of the example system 600, this is done through hardware control mechanisms that can override any software commands, thereby providing a fail-safe or guaranteed method of disabling the component. In some cases, this could be achieved by physically cutting off the power supply to the components, or by using a hardware switch that interrupts the data pathways, preventing any data from being transmitted or processed by these components. The circuit implementation of the hardware logic circuitry 602 and hardware security circuitry 604 described below with reference to FIG. 7 provides an example in which a hardware switch is used to interrupt a data pathway.

In some examples, the hardware component or components force disabled by the hardware security circuitry 604 include one or more cameras (such as left camera 130 or right camera 132), one or more microphones (such as left microphone 206 or right microphone 208), or both. In some examples, the hardware component or components can include a secure data pathway for carrying sensitive data. The sensitive data may include camera data and/or microphone data. In some examples, the secure data pathway is an internal pathway for transmitting the sensitive data between components of the head-worn device. In some examples, the secure data pathway is a network interface for transmitting the sensitive data over a communication network, such as an antenna or data conduit required for the operation of a wired or wireless communication interface, such as a Bluetooth® or WiFi® antenna. Additional examples of communication components and other hardware components for transmitting sensitive data are described below with reference to the machine architecture of FIG. 10.

The system 600 shown in FIG. 6 shows the hardware security circuitry 604 configured to force disable a secure data pathway 606 carrying data between the computer 116 and a camera 608, a microphone 610, and a wireless communication hardware component 612. In some examples, all camera and microphones of the head-worn device are force disabled by the hardware security circuitry 604. In some examples, all wireless communication hardware components 612 of the head-worn device, or all communication components of any kind of the head-worn device, are force disabled by the hardware security circuitry 604. In some cases where multiple secure data pathways 606 are present, the hardware security circuitry 604 may be configured to selectively disable specific pathways based on the type of data they carry, allowing for granular control over the device's security features.

An example implementation of the hardware security circuitry 604 disabling a secure data pathway 606 is described below with reference to FIG. 7.

By performing a hardware-level force disable of sensitive components automatically triggered by an observable physical state of the head-worn device (e.g., folding both temple pieces), examples described herein can provide certainty to users and other bystanders near the head-worn device that sensitive functions of the head-worn device have been disabled. Both users and other people in the presence of a camera-enabled, microphone-enabled, and/or network-enabled device are often uncertain whether the device is recording or uploading data, even when the device appears to be powered off or not in use. Malicious software, compromised device security, user error, or intentional user action can all potentially result in a device that appears to be inactive but is in fact active and recording and/or uploading sensitive data, such that observers may be unsure of the privacy and/or security of their communications in the presence of the device. By providing a robust, observable physical mechanism for disabling these sensitive data functions at the hardware level, independent of control or override by software (malicious or otherwise), examples described herein can assure users and bystanders of the privacy and security of communications and action undertaken while in the presence of the device.

In some examples, the head-worn device includes an indicator 614, such as a light or other visible indicator, that indicates to the user and/or other observers that the head-worn device is in the inactive state with the sensitive hardware components disabled. In some examples, the indicator 614 may be a light positioned on a front-facing surface of the frame 102 of the glasses 100, such as near the left camera 130 or right camera 132. In some examples, the left camera 130 and/or right camera 132 may be covered by a shutter (e.g., a mechanical shutter, or a filter having electrically or thermally controllable opacity) when the device is in the inactive state, and the visibility of this shutter may act as an indicator 614. Other visual or otherwise human-perceptible indicators can be used in various embodiments to alert observers that the head-worn device is in the inactive state. The indicator 614 may be activated by the hardware logic circuitry 602 when the hardware logic circuitry 602 transitions the device to the inactive state, and deactivated by the hardware logic circuitry 602 when the head-worn device transitions to the active state. In some examples, the indicators may instead indicate that the device is active instead of inactive; in such cases, the indicator 614 would be activated along with the device, and deactivated along with the device.

To complement the visual or otherwise human-perceptible indicators of the device's inactive state, the device could also broadcast a short-range signal (e.g., a near-field communication or Bluetooth® signal) detectable by nearby smart devices, informing them of the head-worn device's current privacy mode and ensuring that bystanders are aware of the device's non-recording status.

In some examples, the system 600 may also include a feedback mechanism (not shown) that provides a tactile or auditory signal to the user when the hinges transition between the open and closed positions, thereby confirming the change in state without the need to visually inspect the device. For example, audible cues such as beeps or chimes could sound when the device transitions between states, providing immediate auditory feedback to the user. In some examples, vibration motors in the temple pieces could provide tactile feedback, such as a short buzz to signal that the device has entered an inactive state. In some examples, voice notifications through built-in speakers or connected earphones could announce state changes. In some examples, the head-worn device could send notifications to a paired smartphone app or another mobile device, allowing the user to receive alerts (e.g., activation and/or deactivation alerts) and check the state of the head-worn device on their mobile device.

FIG. 7 illustrates a circuit diagram of an example circuit implementation 700 of the hardware logic circuitry 602 and hardware security circuitry 604 of the system 600 of FIG. 6. In this example, the hardware logic circuitry 602 is implemented as a Schmitt trigger circuit configured to require both signals from the pair of sensors 202, 204 to indicate the same position for both hinges before transitioning the head-worn device between the active state and the inactive state.

In the example circuit implementation 700, two Hall effect sensor are used as the first sensor 202 and second sensor 204. The first sensor 202 is connected to a first sensor resistor 706, and the second sensor 204 is connected to a second sensor resistor 708. In some examples, the first sensor resistor 706 and second sensor resistor 708 each have a resistance of 220 kiloohms. The first sensor 202 generates the first signal via the first sensor resistor 706, and the second sensor 204 generates the second signal via the second sensor resistor 708.

A voltage rail 702 connected to a pull-up resistor 704 sets a threshold voltage for transitioning between the active state and the inactive state. In some examples, the voltage rail 702 has a voltage of 1.8 volts, and the pull-up resistor 704 has a resistance of 150 kiloohms.

A comparator 710 is used for comparing the first signal and second signal to the threshold voltage to generate a comparator output. The comparator 710 is configured as part of an op-amp for amplifying the comparator output, providing a stable signal to control the power state of the device. In some examples, the op-amp includes a comparator resistor 718 having a resistance of 220 kiloohms and a pull-down resistor 712 connected between the comparator output and a ground 714 with a resistance of 1 megaohm.

The hardware security circuitry 604 in this example includes a transistor 716 (e.g., a field effect transistor) that receives the comparator output (in this example, amplified by the op-amp) to act as a switch connecting or disconnecting the secure data pathway 606 to ground 714. When the secure data pathway 606 is grounded, all hardware components relying on the secure data pathway 606 to transmit their data are effectively disabled. Thus, the hardware security circuitry 604 acts to selectively enable or disable at least one hardware component based on the comparator output.

The resistors of the hardware logic circuitry 602 are tuned to ensure that the head-worn device transitions between the active state and the inactive state only when both sensors 202, 204 generate their respective signals to indicate the same hinge position for both hinges. Thus, in some examples, when the first signal generated by the first sensor 202 indicates that the left hinge 124 is in the open position (e.g., the left-side Hall effect sensor of the glasses 100 senses the magnetic field induced by the close proximity of the magnet 302 in the left temple piece 118), and the second signal generated by the second sensor 204 also indicates that the right hinge 126 is in the open position (e.g., the right-side Hall effect sensor of the glasses 100 senses the magnetic field induced by the close proximity of the magnet 302 in the right temple piece 120), then the voltage at the input to the comparator 710 (referred to herein as comparator input 720) is a minimum rising value, such as 0.59 volts. If only one of the temple pieces is folded (fully or partially), thereby generating a first signal or second signal indicating that the left hinge 124 or right hinge 126 is in the closed position, the comparator input 720 voltage rises to a second rising value, such as 0.99 volts. When both of the temple pieces are folded (fully or partially), thereby generating a first signal and second signal indicating that the left hinge 124 and right hinge 126 are both in the closed position, the comparator input 720 voltage rises to a maximum rising value for the comparator input 720 voltage, such as 1.4 volts. In each configuration, the comparator 710 compares the comparator input 720 voltage to the threshold voltage, such as a threshold voltage between 1.118 volts and 1.212 volts. Only when the comparator input 720 voltage rises above the threshold voltage are the glasses 100 transitioned to the inactive state and the transistor 716 of the hardware security circuitry 604 switched on, grounding the secure data pathway 606 to ground 714. Furthermore, because the maximum rising value of 1.4 volts is greater than the rising threshold voltage (e.g., between 1.118 volts and 1.212 volts), the comparator 710 toggles to a high voltage output state, pulling the voltage of the output of the comparator 710 (referred to herein as comparator output 722) up to 1.8 volts from its input voltage of 1.4 volts. This additional increase in comparator output 722 voltage provides additional hysteresis when transitioning the voltage back down to an unfolded state, as described below.

Similarly, when the glasses are closed and inactive, with the first signal and second signal indicating that the left hinge 124 and right hinge 126 are both in the closed position, the comparator input 720 voltage is at its maximum value, such as 1.8 volts. If only one of the temple pieces is unfolded to the open position, thereby generating a first signal or second signal indicating that the left hinge 124 or right hinge 126 is in the open position, the comparator output 722 voltage falls to a second falling value, such as 1.4 volts. When both of the temple pieces are unfolded, thereby generating a first signal and second signal indicating that the left hinge 124 and right hinge 126 are both in the open position, the voltage falls to the minimum falling value, such as 0.99 volts. In each configuration, the comparator 710 compares this voltage to the threshold voltage, such as a falling threshold voltage between 1.168 volts and 1.192 volts. Only when the voltage falls below the falling threshold voltage are the glasses 100 transitioned to the active state and the transistor 716 of the hardware security circuitry 604 switched off, disconnecting the secure data pathway 606 from ground 714 and thereby re-enabling the secure data pathway 606 and any hardware components reliant on the secure data pathway 606. Furthermore, because the minimum falling value of 0.99 volts is lower than the falling threshold voltage (e.g., between 1.168 volts and 1.192 volts), the comparator 710 toggles to a low voltage output state, pulling the voltage of the comparator output 722 down to 0.59 volts. This additional decrease in comparator output 722 voltage provides additional hysteresis when transitioning the voltage back down to a folded state. (It will be appreciated that, although the second falling value is equal to the maximum comparator input 720 value and the minimum falling value is equal to the second rising value in this example, other examples may use different values.)

The values of the various voltages, resistances, and thresholds can be varied in different examples. For example, the resistance values of the resistors may depend on the comparator 710 used and the voltage rail 702 used. It could also depend on the number of sensors used. In the illustrated example, two sensors (first sensor 202 and second sensor 204) are required to change state, thereby propagating a voltage that crosses an internal reference (e.g., a threshold voltage of approximately 1.2 volts) inside the comparator 710. However, some examples may use a comparator without an integrated reference. The resistance value of the first sensor resistor 706 and second sensor resistor 708 could change if a different reference voltage were to be used, or if a larger level of hysteresis were desired. In some examples, the rising threshold voltage and the falling threshold voltage may be equal.

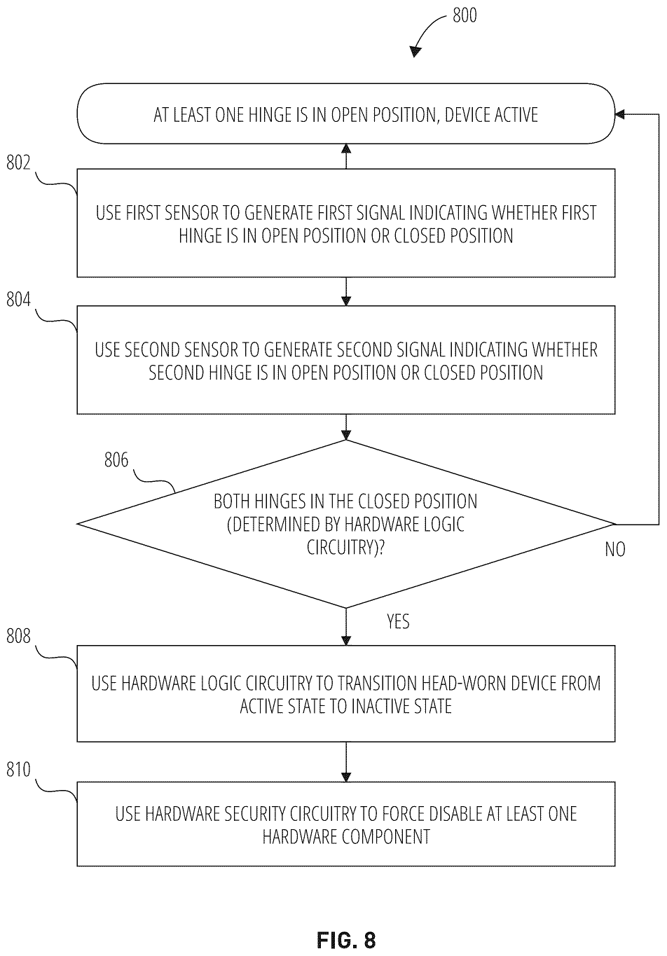

FIG. 8 is a flowchart illustrating operations of a first example method 800 for controlling a head-worn device.

Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

Method 800 begins at a start condition in which at least one hinge (e.g., left hinge 124 and/or right hinge 126) is in the open position, and the head-worn device (e.g., glasses 100) is in the active state.

According to some examples, the method 800 includes using a first sensor (e.g., first sensor 202) to generate a first signal indicating whether a first hinge (e.g., left hinge 124) is in open position or closed position at operation 802.

According to some examples, the method 800 includes using a second sensor (e.g., second sensor 204) to generate a second signal indicating whether a second hinge (e.g., right hinge 126) is in open position or closed position at operation 804.

According to some examples, the method 800 includes using hardware logic circuitry 602 to determine whether the first signal and the second signal indicate that the first hinge and second hinge are both in the closed position at operation 806. If the hardware logic circuitry 602 determines that the first hinge and second hinge are both in the closed position, the method 800 proceeds to operation 808; otherwise, the method 800 returns to the start condition.

According to some examples, the method 800 includes using the hardware logic circuitry 602 to transition the head-worn device from the active state to the inactive state at operation 808.

According to some examples, the method 800 includes using hardware security circuitry 604 to force disable at least one hardware component at operation 810.

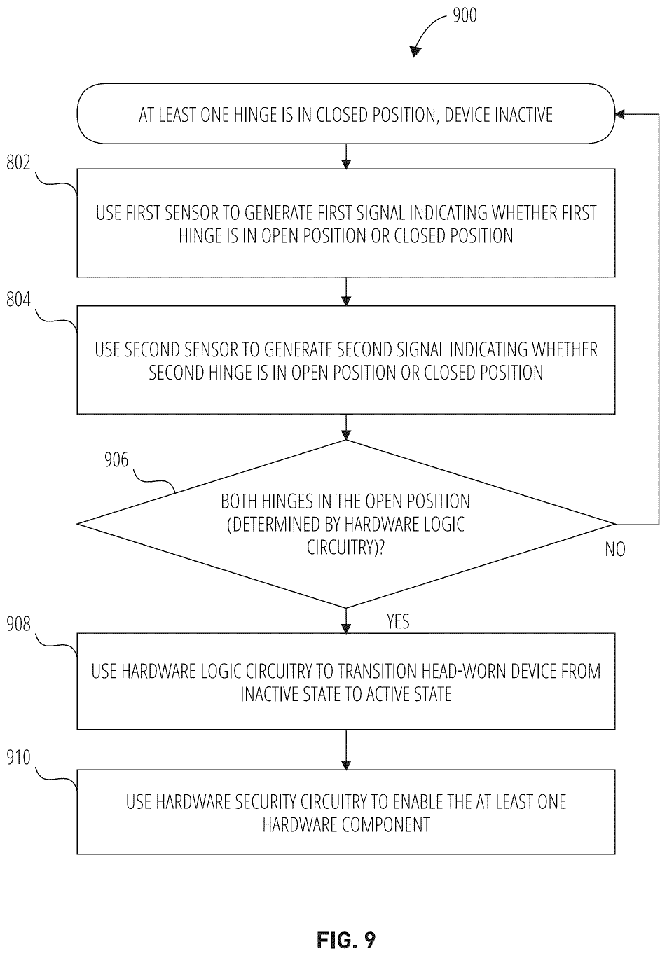

FIG. 9 is a flowchart illustrating operations of a second example method 900 for controlling a head-worn device.

Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

Method 900 begins at a start condition in which at least one hinge (e.g., left hinge 124 and/or right hinge 126) is in the closed position, and the head-worn device (e.g., glasses 100) is in the inactive state.

According to some examples, the method 900 includes using a first sensor (e.g., first sensor 202) to generate a first signal indicating whether a first hinge (e.g., left hinge 124) is in open position or closed position at operation 802. This is equivalent to operation 802 of method 800.

According to some examples, the method 900 includes using a second sensor (e.g., second sensor 204) to generate a second signal indicating whether a second hinge (e.g., right hinge 126) is in open position or closed position at operation 804. This is equivalent to operation 804 of method 800.

According to some examples, the method 900 includes using hardware logic circuitry 602 to determine whether the first signal and the second signal indicate that the first hinge and second hinge are both in the open position at operation 906. If the hardware logic circuitry 602 determines that the first hinge and second hinge are both in the open position, the method 900 proceeds to operation 908; otherwise, the method 900 returns to the start condition.

According to some examples, the method 900 includes using the hardware logic circuitry 602 to transition the head-worn device from the inactive state to the active state at operation 908.

According to some examples, the method 900 includes using hardware security circuitry 604 to force disable at least one hardware component at operation 910.

### Machine Architecture

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. In some examples, the machine 1000 may comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1008, which may be configured to communicate with each other via a bus 1010. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1012 and a processor 1014 that execute the instructions 1002. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display, a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include motion components 1030, environmental components 1032, or position components 1034, among a wide array of other components. For example, the motion components 1030 include acceleration sensor components (e.g., accelerometer), gravitation sensor components, and/or rotation sensor components (e.g., gyroscope).

The environmental components 1032 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise, such as left microphone 206 and right microphone 208, and/or microphone 610), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that may provide indications, measurements, or signals corresponding to a surrounding physical environment.

With respect to cameras, the machine 1000 may have a camera system comprising, for example, front cameras on a front surface of the machine 1000 and rear cameras on a rear surface of the machine 1000. In addition to front and rear cameras, the machine 1000 may also include a 360° camera for capturing 360° photographs and videos. The front cameras may include the left camera 130 and right camera 132 of the glasses 100 of FIG. 1 through FIG. 5, and/or the camera 608 of FIG. 6.

Further, the camera system of the machine 1000 may include dual rear cameras (e.g., a primary camera as well as a depth-sensing camera), or even triple, quad or penta rear camera configurations on the front and rear sides of the machine 1000. These multiple cameras systems may include a wide camera, an ultra-wide camera, a telephoto camera, a macro camera, and a depth sensor, for example. The system may additionally include infra-red cameras to permit hand gesture tracking, eye position tracking or night vision, for example.

The position components 1034 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, satellite communication, Near Field Communication (NFC) components, Bluetooth® components (e.g., Bluetooth® Low Energy), Wi-Fi® components, Zigbee, Ant+, and other communication components to provide communication via other modalities. The devices 1040 may be another machine or any of a wide variety of peripheral devices (e.g., a peripheral device coupled via a USB). The communication components 1036 can include a wireless communication subsystem including the wireless communication hardware component 612 of FIG. 6.

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

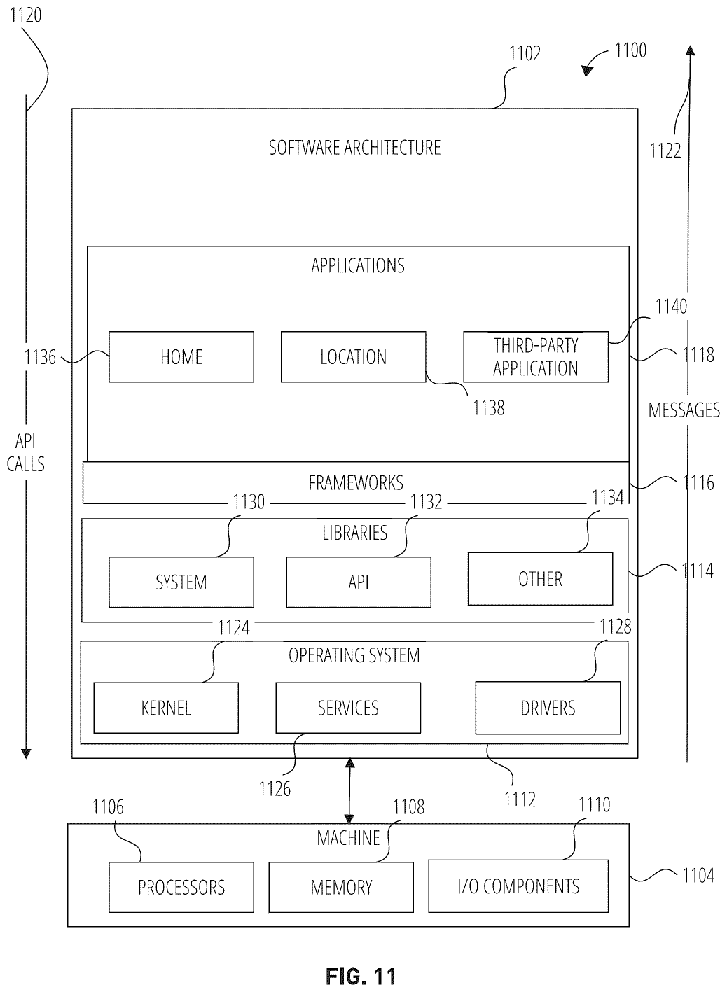

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and Applications 1118. Operationally, the Applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the Applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the Applications 1118.

The frameworks 1116 provide a common high-level infrastructure that is used by the Applications 1118. For example, the frameworks 1116 provide various graphical user interface (GUI) functions, high-level resource management, and high-level location services. The frameworks 1116 can provide a broad spectrum of other APIs that can be used by the Applications 1118, some of which may be specific to a particular operating system or platform.

In an example, the Applications 1118 may include a home application 1136, a location application 1138, and a broad assortment of other Applications such as a third-party application 1140. The Applications 1118 are programs that execute functions defined in the programs. Various programming languages can be employed to create one or more of the Applications 1118, structured in a variety of manners, such as object-oriented programming languages (e.g., Objective-C, Java, or C++) or procedural programming languages (e.g., C or assembly language). In a specific example, the third-party application 1140 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1140 can invoke the API calls 1120 provided by the operating system 1112 to facilitate functionalities described herein.

### CONCLUSION

Some examples described herein may attempt to address one or more technical problems in the design of head-worn devices such as XR glasses. Limitations of manual power switches and proximity sensors can be addressed by an intuitive, robust configuration in which a simple circuit using small sensors is used to force disable and power down the device in response to a user folding both temple pieces of the glasses to a closed position. The device can then be powered on and the hardware re-enabled by unfolding both temple pieces of the glasses into an open position.

Thus, examples may provide a head-worn device, such as XR glasses, incorporating a mechanism for controlling power and security states through the use of hinge-integrated sensors, such as Hall effect sensors. This approach ensures that the device transitions seamlessly between active and inactive states in response to the physical manipulation of the eyewear's temple pieces. The ability to force disable critical components like cameras and microphones via hardware logic circuitry, independent of software control, provides an additional layer of security and privacy, offering users and other observers peace of mind that their device is not surreptitiously recording or transmitting data.

Example 1 is a head-worn device comprising: a pair of hinges, each hinge configured to transition between an open position and a closed position, each hinge pivotally coupling a respective temple piece of the head-worn device to a frame of the head-worn device; a sensor associated with each of the pair of hinges, configured to detect the position of the respective hinge and output a signal indicative of the hinge's position; hardware logic circuitry configured to receive the signals from the sensors and to control a state of the head-worn device based on the detected positions of both hinges, wherein the head-worn device transitions from an inactive state to an active state when both hinges are detected in the open position and transitions from the active state to the inactive state when both hinges are detected in the closed position; and hardware security circuitry configured to force disable at least one hardware component of the head-worn device when the head-worn device is in the inactive state.

In Example 2, the subject matter of Example 1 includes, wherein: the at least one hardware component comprises at least one of a camera or a microphone.

In Example 3, the subject matter of Examples 1-2 includes, wherein: the sensors associated with the hinges comprise Hall effect sensors configured to detect a change in magnetic field when the respective hinge transitions between the open position and the closed position.

In Example 4, the subject matter of Examples 1-3 includes, wherein: the sensors associated with the hinges comprise electrical contact sensors configured to detect a respective electrical circuit: closing when the respective hinge transitions from the closed position to the open position; and opening when the respective hinge transitions from the open position to the closed position.

In Example 5, the subject matter of Examples 3-4 includes, wherein: each hinge, while in the open position, causes corresponding faces of a respective temple piece and the frame to abut each other; one of the faces includes a magnet; and the other of the faces includes the Hall effect sensor, such that the Hall effect sensor senses the magnetic field of the magnet only when the corresponding faces are abutting each other.

In Example 6, the subject matter of Examples 1-5 includes, wherein: the hardware logic circuitry comprises a Schmitt trigger circuit configured to require both signals from the pair of sensors to indicate a same position for both hinges before transitioning the head-worn device between the active state and the inactive state.

In Example 7, the subject matter of Example 6 includes, wherein: the Schmitt trigger circuit comprises one or more resistors tuned to ensure that the head-worn device transitions between the active state and the inactive state only when both sensors generate their respective signals to indicate the same hinge position for both hinges.

In Example 8, the subject matter of Example 7 includes, wherein: the Schmitt trigger circuit comprises: a pull-up resistor connected to a voltage rail of the head-worn device to set a threshold voltage; and a comparator for comparing the signals to the threshold voltage to generate a comparator output; and the hardware security circuitry comprises: a transistor configured to enable or disable the at least one hardware component based on the comparator output.

In Example 9, the subject matter of Examples 1-8 includes, wherein: the hardware logic circuitry is configured to maintain the head-worn device in a sleep state for a predetermined time period before transitioning to the inactive state if the hinges remain in the closed position for the predetermined time period.

In Example 10, the subject matter of Examples 1-9 includes, wherein: force disabling the at least one hardware component comprises force disabling a secure data pathway for carrying sensitive data, the sensitive data comprising at least one of camera data or microphone data.

In Example 11, the subject matter of Example 10 includes, wherein: the secure data pathway comprises a network interface for transmitting the sensitive data over a communication network.

In Example 12, the subject matter of Examples 1-11 includes, wherein: the hardware logic circuitry and hardware security circuitry are configured to operate independently of software control.

In Example 13, the subject matter of Examples 1-12 includes, wherein: the head-worn device is configured, when in the inactive state, to present an indication, perceptible by human bystanders, that the head-worn device is inactive.

Example 14 is a method of controlling a head-worn device, comprising: generating a first signal indicating that a first hinge of the head-worn device is in an open position or a closed position using a first sensor associated with the first hinge, the first hinge pivotally coupling a first temple piece to a frame of the head-worn device; generating a second signal indicating that a second hinge of the head-worn device is in an open position or a closed position using a second sensor associated with the second hinge, the second hinge pivotally coupling a second temple piece to a frame of the head-worn device; using hardware logic circuitry to determine that the first signal and the second signal indicate that the first hinge and the second hinge are both in the closed position; and in response to the hardware logic circuitry detecting that the first hinge and the second hinge are both in the closed position: using the hardware logic circuitry to transition the head-worn device from an active state to an inactive state; and using hardware security circuitry to force disable at least one hardware component of the head-worn device.

In Example 15, the subject matter of Example 14 includes, wherein: the at least one hardware component comprises at least one of a camera or a microphone.

In Example 16, the subject matter of Examples 14-15 includes, using the hardware logic circuitry to determine that the first signal and the second signal indicate that the first hinge and the second hinge are both in the open position; and in response to the hardware logic circuitry detecting that the first hinge and the second hinge are both in the open position: using the hardware logic circuitry to transition the head-worn device from the inactive state to the active state; and using the hardware security circuitry to enable the at least one hardware component.

In Example 17, the subject matter of Examples 14-16 includes, wherein: the first sensor and second sensor each comprise a Hall effect sensor configured to detect a change in magnetic field when the respective hinge transitions between the open position and the closed position.

In Example 18, the subject matter of Examples 14-17 includes, maintaining the head-worn device in a sleep state for a predetermined time period before transitioning to the inactive state if the hinges remain in the closed position for the predetermined time period.

In Example 19, the subject matter of Examples 14-18 includes, wherein: the hardware logic circuitry and hardware security circuitry are configured to operate independently of software control.

Example 20 is a system for controlling a head-worn device, comprising: a pair of hinges integrated into the head-worn device, each hinge configured to transition between an open position and a closed position, each hinge pivotally coupling a respective temple piece of the head-worn device to a frame of the head-worn device; means for detecting the position of each hinge; means for controlling a state of the head-worn device based on the detected positions of both hinges, the head-worn device transitioning from an inactive state to an active state when both hinges are detected in the open position and transitioning from the active state to the inactive state when both hinges are detected in the closed position; and means for force disable at least one hardware component of the head-worn device when the head-worn device is in the inactive state.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Changes and modifications may be made to the disclosed examples without departing from the scope of the present disclosure. These and other changes or modifications are intended to be included within the scope of the present disclosure, as expressed in the following claims.

### Glossary

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology. The term “network”, as used herein, shall refer to a communication network unless otherwise indicated.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A head-worn device comprising:
a pair of hinges, each hinge configured to transition between an open position and a closed position, each hinge pivotally coupling a respective temple piece of the head-worn device to a frame of the head-worn device;
a sensor associated with each of the pair of hinges, configured to detect the position of the respective hinge and output a signal indicative of the hinge's position;
hardware logic circuitry configured to receive the signals from the sensors and to control a state of the head-worn device based on the detected positions of both hinges, wherein the head-worn device transitions from an inactive state to an active state when both hinges are detected in the open position and transitions from the active state to the inactive state when both hinges are detected in the closed position; and
hardware security circuitry configured to force disable at least one hardware component of the head-worn device when the head-worn device is in the inactive state.

2. The head-worn device of claim 1, wherein:
the at least one hardware component comprises at least one of a camera or a microphone.

3. The head-worn device of claim 1, wherein:
the sensors associated with the hinges comprise Hall effect sensors configured to detect a change in magnetic field when the respective hinge transitions between the open position and the closed position.

4. The head-worn device of claim 1, wherein:
the sensors associated with the hinges comprise electrical contact sensors configured to detect a respective electrical circuit:
closing when the respective hinge transitions from the closed position to the open position; and
opening when the respective hinge transitions from the open position to the closed position.

5. The head-worn device of claim 3, wherein:
each hinge, while in the open position, causes corresponding faces of a respective temple piece and the frame to abut each other;
one of the faces includes a magnet; and
the other of the faces includes the Hall effect sensor,
such that the Hall effect sensor senses the magnetic field of the magnet only when the corresponding faces are abutting each other.

6. The head-worn device of claim 1, wherein:
the hardware logic circuitry comprises a Schmitt trigger circuit configured to require both signals from the pair of sensors to indicate a same position for both hinges before transitioning the head-worn device between the active state and the inactive state.

7. The head-worn device of claim 6, wherein:
the Schmitt trigger circuit comprises one or more resistors tuned to ensure that the head-worn device transitions between the active state and the inactive state only when both sensors generate their respective signals to indicate the same hinge position for both hinges.

8. The head-worn device of claim 7, wherein:
the Schmitt trigger circuit comprises:
a pull-up resistor connected to a voltage rail of the head-worn device to set a threshold voltage; and
a comparator for comparing the signals to the threshold voltage to generate a comparator output; and
the hardware security circuitry comprises:
a transistor configured to enable or disable the at least one hardware component based on the comparator output.

9. The head-worn device of claim 1, wherein:
the hardware logic circuitry is configured to maintain the head-worn device in a sleep state for a predetermined time period before transitioning to the inactive state if the hinges remain in the closed position for the predetermined time period.

10. The head-worn device of claim 1, wherein:
force disabling the at least one hardware component comprises force disabling a secure data pathway for carrying sensitive data, the sensitive data comprising at least one of camera data or microphone data.

11. The head-worn device of claim 10, wherein:
the secure data pathway comprises a network interface for transmitting the sensitive data over a communication network.

12. The head-worn device of claim 1, wherein:
the hardware logic circuitry and hardware security circuitry are configured to operate independently of software control.

13. The head-worn device of claim 1, wherein:
the head-worn device is configured, when in the inactive state, to present an indication, perceptible by human bystanders, that the head-worn device is inactive.

14. A method of controlling a head-worn device, comprising:
generating a first signal indicating that a first hinge of the head-worn device is in an open position or a closed position using a first sensor associated with the first hinge, the first hinge pivotally coupling a first temple piece to a frame of the head-worn device;
generating a second signal indicating that a second hinge of the head-worn device is in an open position or a closed position using a second sensor associated with the second hinge, the second hinge pivotally coupling a second temple piece to a frame of the head-worn device;
using hardware logic circuitry to determine that the first signal and the second signal indicate that the first hinge and the second hinge are both in the closed position; and
in response to the hardware logic circuitry detecting that the first hinge and the second hinge are both in the closed position:
using the hardware logic circuitry to transition the head-worn device from an active state to an inactive state; and
using hardware security circuitry to force disable at least one hardware component of the head-worn device.

15. The method of claim 14, wherein:
the at least one hardware component comprises at least one of a camera or a microphone.

16. The method of claim 14, further comprising:
using the hardware logic circuitry to determine that the first signal and the second signal indicate that the first hinge and the second hinge are both in the open position; and
in response to the hardware logic circuitry detecting that the first hinge and the second hinge are both in the open position:
using the hardware logic circuitry to transition the head-worn device from the inactive state to the active state; and
using the hardware security circuitry to enable the at least one hardware component.

17. The method of claim 14, wherein:
the first sensor and second sensor each comprise a Hall effect sensor configured to detect a change in magnetic field when the respective hinge transitions between the open position and the closed position.

18. The method of claim 14, further comprising:
maintaining the head-worn device in a sleep state for a predetermined time period before transitioning to the inactive state if the hinges remain in the closed position for the predetermined time period.

19. The method of claim 14, wherein:
the hardware logic circuitry and hardware security circuitry are configured to operate independently of software control.

20. A system for controlling a head-worn device, comprising:
a pair of hinges integrated into the head-worn device, each hinge configured to transition between an open position and a closed position, each hinge pivotally coupling a respective temple piece of the head-worn device to a frame of the head-worn device;
means for detecting the position of each hinge;
means for controlling a state of the head-worn device based on the detected positions of both hinges, the head-worn device transitioning from an inactive state to an active state when both hinges are detected in the open position and transitioning from the active state to the inactive state when both hinges are detected in the closed position; and
means for force disable at least one hardware component of the head-worn device when the head-worn device is in the inactive state.
